(19) United States
(12) Patent Application Publication
(10) Pub. No.: US 2026/0195467 A1
(43) Pub. Date: Jul. 9, 2026

(54) SECURE GATEWAY FOR INTERACTING WITH LARGE LANGUAGE MODELS

(71) Applicant: NTT DATA Americas, Inc., Plano, TX (US)

(72) Inventors: Aananthanarayanan Pandian, Chennai (IN); Ujjwal Sharma, Chennai (IN); Tanvir Khan, Allen, TX (US); Dhurai Ganesan, Chennai (IN); Nareshkumar Gunasekaran, Kanchipuram (IN)

(21) Appl. No.: 19/012,672

(22) Filed: Jan. 7, 2025

(51) Int. Cl. G06F 21/62

(52) U.S. Cl. CPC G06F 21/6218

(57) ABSTRACT

In an embodiment, a method of securing interaction with public large language models (LLMs) includes intercepting input data to a public LLM. The method also includes processing the input data based on a data policy applicable to the public LLM. The method also includes providing the processed input data to the public LLM. The method also includes intercepting output data from the public LLM that is responsive to the processed input data. The method also includes processing the output data based on the data policy applicable to the public LLM. The method also includes providing the processed output data to a requestor associated with the input data.

### INTRODUCTION

Data security is a significant objective in most organizations. As a general matter, it is important to prevent sensitive information from being leaked, breached, or lost to a third party.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, in an embodiment, a method of securing interaction with public large language models (LLMs) includes intercepting input data to a public LLM. The method also includes processing the input data based on a data policy applicable to the public LLM. The method also includes providing the processed input data to the public LLM. The method also includes intercepting output data from the public LLM that is responsive to the processed input data. The method also includes processing the output data based on the data policy applicable to the public LLM. The method also includes providing the processed output data to a requestor associated with the input data.

In another general aspect, in an embodiment, a system includes a processor and memory, where the processor and memory in combination are operable to implement a method. The method includes intercepting input data to a public LLM. The method also includes processing the input data based on a data policy applicable to the public LLM. The method also includes providing the processed input data to the public LLM. The method also includes intercepting output data from the public LLM that is responsive to the processed input data. The method also includes processing the output data based on the data policy applicable to the public LLM. The method also includes providing the processed output data to a requestor associated with the input data.

In another general aspect, in an embodiment, a computer-program product includes a non-transitory computer-usable medium having computer-readable program code embodied therein, the computer-readable program code adapted to be executed to implement a method. The method includes intercepting input data to a public LLM. The method also includes processing the input data based on a data policy applicable to the public LLM. The method also includes providing the processed input data to the public LLM. The method also includes intercepting output data from the public LLM that is responsive to the processed input data. The method also includes processing the output data based on the data policy applicable to the public LLM. The method also includes providing the processed output data to a requestor associated with the input data.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 illustrates an example computing environment for implementing a data processing system.

FIG. 2 illustrates example operation of the model gateway of FIG. 1.

FIG. 3 illustrates an example of the model gateway of FIG. 1.

FIG. 4 illustrates an example of a process for configuring a data policy that may be applicable to one or more external models.

FIG. 4 illustrates an example of a process for securing machine learning models from malicious data.

FIG. 5 illustrates an example of a process for facilitating real-time implementation of secured access to external data models.

FIG. 6 illustrates an example of processing input data according to the process of FIG. 5.

FIG. 7 illustrates an example of processing output data according to the process of FIG. 5.

FIG. 8 illustrates an example of a computer system.

### DETAILED DESCRIPTION

In certain embodiments, data processing can occur via one or more machine learning (ML) algorithms or other algorithms that are applied to incoming data streams. In various cases, the data processing can involve performing particular tasks with respect to the incoming data streams. The particular tasks can involve, for example, predicting data, generating new data, performing configurable workflows, combinations of the foregoing and/or the like. ML can use various techniques to learn to perform the particular tasks, without being explicitly programmed for the tasks, in some cases using training data that is of a same format as the incoming data stream. In general, ML can encompass various types of algorithms such as, for example, decision tree learning, association rule learning, artificial neural networks (including deep learning and, in particular, feed forward networks), inductive logic programming, support vector machines, clustering, Bayesian networks, reinforcement learning, representation learning, similarity and metric learning, sparse dictionary learning, genetic algorithms, rule-based ML, gradient boosting, ML based on generalized linear modeling, random forest, ensemble learning, combinations of the foregoing and/or the like.

Further to the above, in certain embodiments, data processing can occur via third-party generative artificial intelligence (AI) software, such as chatbots, virtual assistants and/or the like. In general, the third-party generative AI software can operate based on large language models (LLMs). Examples of such third-party generative AI software include OPENAI CHATGPT, GOOGLE GEMINI, and MICROSOFT COPILOT.

Problematically, the risks associated with accessing third-party generative AI software can be significant. For example, there is no control of what happens to data that flows into LLMs. Data that is shared with shared with generative AI software may become part of an associated LLM. In general, this lack of control is particularly problematic if the data that is shared includes sensitive or confidential information.

Existing methods of accessing third-party generative AI software typically involve no validation of unwanted data transmission. Therefore, there is a high possibility that sensitive, confidential, and/or unwanted information can be transmitted along with other data. This information may include, for example, protected health information (PHI), financial data, personal identifiable information (PII) such as social security numbers, and/or the like. For example, data transmitted from a healthcare-related application may contain PHI, which information cannot be disclosed to any third party. Such information, when transmitted to an LLM, may lead to privacy, ethical and legal issues for an organization. Further, data returned from the LLM may contain unnecessary information.

The present disclosure describes examples of implementing a secure gateway for accessing external models such as, for example, external LLMs that drive third-party generative AI software. In certain aspects, the secure gateway can intercept and process input data directed to an external LLM (e.g., one or more prompts for the external LLM) as the input data flows from a requestor to the external LLM, such that the processed input data is provided to the external LLM instead of the original input data. For example, the secure gateway can filter confidential, sensitive and/or unwanted information from the input data while also preserving a context of the data. In addition, or alternatively, in certain aspects, the secure gateway can intercept and process output data from the external LLM (e.g., one or more responses to the input data) as the output data flows from the external LLM to the requestor, such that the processed output data is provided to the requestor instead of the original output data. In this way, the secure gateway can bi-directionally secure access to the external LLM. Examples will be described relative to the Drawings.

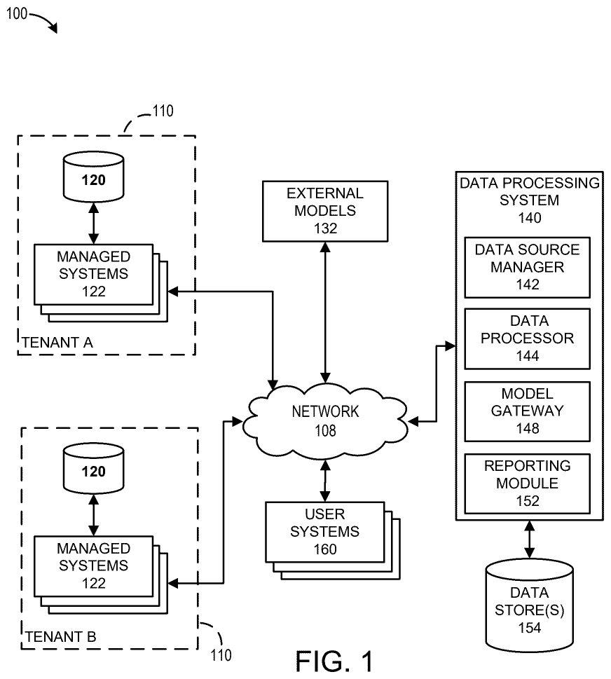

FIG. 1 illustrates an example computing environment 100 for implementing a data processing system 140. The computing environment 100 includes the data processing system 140, tenant systems 110, external models 132, user systems 160 and data store(s) 154, each of which is operable to communicate over a network 108. The network 108 may be a private network, a public network, a local or wide area network, a portion of the Internet, combinations of the same, and/or the like.

In certain embodiments, the data processing system 140 can centrally manage data processing of data sources for its tenants. In particular, in the computing environment 100, the tenant systems 110 can be served by the data processing system 140. The tenant systems 110 shown can be owned or operated by the same or different entities. For example, one of the tenant systems 110 is shown as owned or operated by “Tenant A” while another system 110 is owned or operated by a different tenant, “Tenant B.” The tenant systems 110 shown can be owned or operated by the same or different entities. For example, Tenants A and B can represent customers (e.g., entities such as companies or individuals) of an operator of the data processing system 140. Although the term “tenant” is used herein to describe the systems 110 or owners/operators thereof, in addition to having its ordinary meaning, the term “tenant” can, but need not, refer to tenancy in a multitenant software architecture.

More specifically, the tenant systems 110 can include one or more computer systems 122 that are each communicably coupled to, or include, one or more managed data sources 120. The one or more managed data sources 120 can include data streams or datasets that can be processed by the data processing system 140. In various cases, the one or more data sources 120 can be updated by the computer systems 122, or other components, in real-time, on a periodic basis, e.g., according to a schedule, on-demand or a combination of the same. Although the tenant systems 110 are shown as separate from each other and the data process system 140, in some aspects, each of the tenant systems 110 can be implemented on the data processing system 140.

In the illustrated embodiment, the data processing system 140 can include a data source manager 142, a data processor 144, a model gateway 148, and a reporting module 152. Each of these components can be implemented with hardware and/or software, including (optionally) virtual machines or containers. In an example, the data processing system 140 can be implemented as a single management server. In another example, the data processing system 140 can be implemented in a plurality of virtual or physical servers, which may or may not be geographically co-located. In some embodiments, the data processing system 140 and/or other aspects of the computing environment 100 may be hosted on a cloud-provider system such as the Azure™ service provided by Microsoft® or the EC2™ platform provided by Amazon®.

In certain embodiments, features of the components of the data processing system 140 can be made accessible over an interface to the user systems 160. The user systems 160 can include any type of computing device, including computer systems such as desktops, laptops, tablets, smartphones, media devices, and wearable computers such as smartwatches or headsets, to name a few. The user systems 160 can be operated by users associated with the tenants or by other users.

The data source manager 142 can coordinate the managed data sources 120 In various embodiments, the data source manager 142 can identify, receive, pull, and/or communicate with the computer systems 122 so as to enable processing of the managed data sources 120. In some embodiments, the data source manager 142 can serve a data collection function. In these embodiments, the computer systems 122 can obtain or collect datasets in real-time, periodically, e.g., according to a schedule, on-demand, or a combination of the same. In some cases, such datasets can be provided as a live stream. In some cases, data from the managed data sources 120 can be collected and stored in the data store(s) 154. In other cases, the data can remain at the managed data sources 120.

The data processor 144 can process data according to a plurality of algorithms supported thereby (e.g., ML-based and/or rule-based algorithms), potentially using different configuration settings and/or algorithms for different data sources. The processing performed by the data processor 144 can involve executing particular tasks with respect to the data such as, for example, data prediction, generation of new data, execution of configurable workflows (e.g., processing medical claims), combinations of the foregoing and/or the like. Models representing the algorithms and/or the configuration settings for such algorithms can be stored, for example, in the data store(s) 154. In addition, or alternatively, the data processor 144 can facilitate data processing, for example, by the user systems 160. In some aspects, the data processor 144 can provide an interface to the user systems 160 for performing data processing.

In certain aspects, the data processor 144 and/or users of the user systems 160 can access external models 132 to perform certain functions. The external models 132 can represent, for example, publicly available models that are accessible over the network 108. The external models 132 can include, for example, external LLMs that drive third-party generative AI software and/or other external models, as discussed previously.

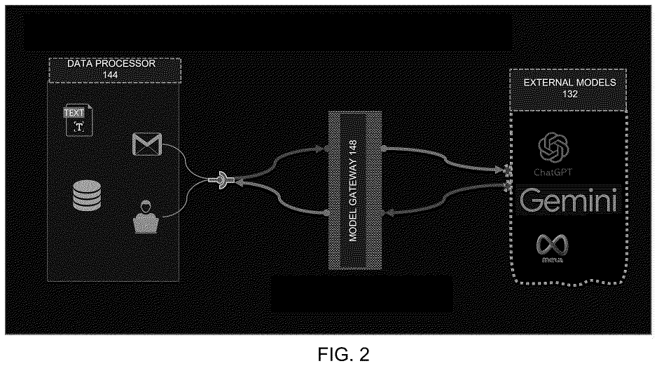

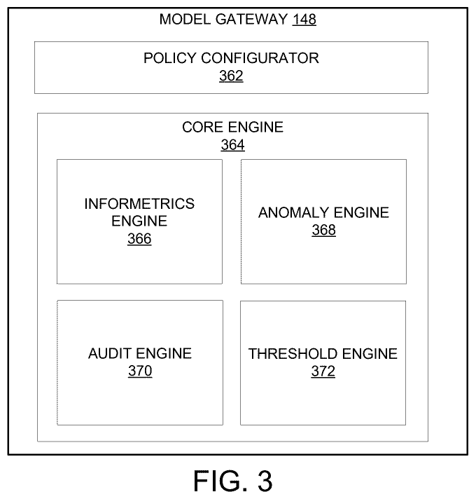

In certain aspects, the model gateway 148 can provide secured access to the external models 132, for example, to the data processor 144, the user systems 160, and/or other systems components. In certain aspects, as shown in FIG. 2, the model gateway 148 can intercept input data directed to any of the external models 132 (e.g., one or more prompts for any of the external models 132) as the input data flows from any of the aforementioned systems or components to the external models 132, such that the processed input data is provided to the external models 132 instead of the original input data. For example, the model gateway 148 can filter confidential, sensitive and/or unwanted information from the input data while also preserving a context of the data. In addition, or alternatively, in certain aspects, the model gateway 148 can intercept and process output data from the external models 132 (e.g., one or more responses to the input data) as the output data flows from the external models 132 to the data processor 144, the user systems 160 and/or other systems or components, such that the processed output data is provided to such systems or components instead of the original output data. In this way, the model gateway 148 can bi-directionally secure access to the external models 132. An example of the model gateway 148 will be described relative to FIG. 3.

The reporting module 152 can generate regular or on-demand reports related to the data processor 144, the policy configurator 362, the model gateway 148, and/or any other component of the computing environment 100. The reporting module 152 can publish reports or other generated information, for example, to a web page, dashboard, and/or the like. The reporting module 152 can also generate and execute a query of the data store(s) 154. The web page, user dashboard or other user interface(s) output, for example, by the reporting module 152, can be accessed by users of the user systems 160. The reporting module 152 can also provide a user interface, for instance, that allows the users of the user systems 160 to obtain customized data related to any data maintained by the data store(s) 154.

In general, the data store(s) 154 can include any information collected, stored, used, produced and/or output by the data processing system 140 or a component thereof. For example, in various embodiments, the data store(s) 154 can include ML models, ML frameworks, identification of ML models used for particular managed data sources of the managed data sources 120, software, training datasets, ML threat signatures, data collected or received from the managed data sources 120, data processed by the data processor 144, combinations of the same and/or the like. In certain embodiments, data stored in the data store(s) 154 can take the form of repositories, flat files, databases, etc.

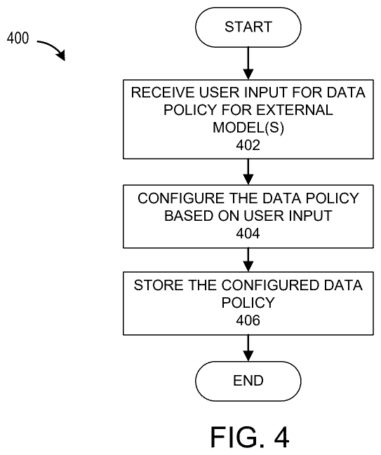

FIG. 3 illustrates an example of the model gateway 148. The model gateway 148 is shown to include a policy configurator 362 and a core engine 364. In certain aspects, the policy configurator 362 can configure one or more policies for accessing and/or receiving data from the external models 132. The one or more policies can be stored, for example, in the data store(s) 154 of FIG. 1. A given policy can include, for example, one or more rules defining how to process input data directed to any of the external models 132. In addition, or alternatively, a given policy can include, for example, one or more rules defining how to process output data from any of the external models 132. Example operation of the policy configurator 362 will be described relative to FIG. 4.

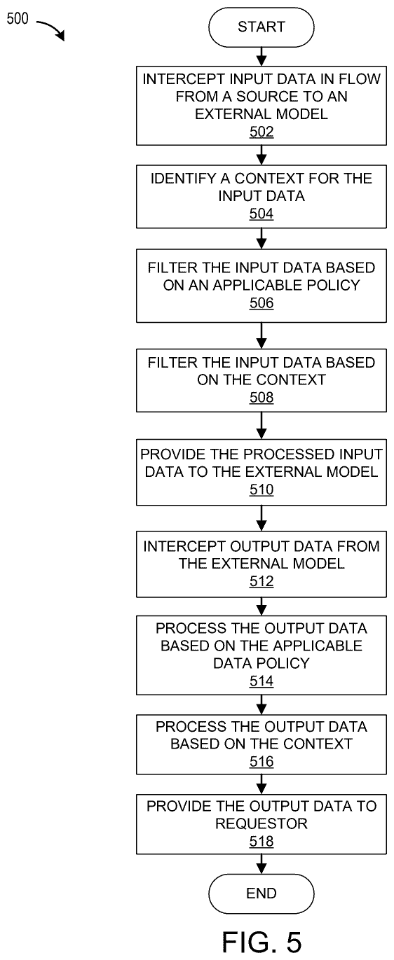

In certain aspects, the core engine 364 can facilitate real-time implementation of secured access to the external data models 132. In certain aspects, the core engine 364 can intercept and process input data to the external data models 132 and/or intercept and process output data from the external data models 132. The processing can based on, for example, the data policies described above, a context of use, and/or other configuration. The core engine 364 can include, for example, an informetrics engine 366, an anomaly engine 368, an audit engine 370, and a threshold engine 372. Example operation of the components of the core engine 364 will be described relative to FIGS. 4 and 5.

FIG. 4 illustrates an example of a process 400 for configuring a data policy that may be applicable to one or more external models. In certain embodiments, the process 400 can be executed, for example, by the model gateway 148 of FIG. 1 or the policy configurator 362 of FIG. 3. The process 400 can also be executed generally by the data processing system 140 of FIG. 1. Although the process 400 can be executed by any number of different components, to simplify discussion, the process 400 will be described relative to the policy configurator 362 of FIG. 3.

At block 402, the policy configurator 362 receives user input for a data policy for one or more external models, such as any one or more of the external models 132 of FIG. 1. In some aspects, the user input can include a policy document that is automatically processed by the policy configurator 362. In addition, or alternatively, the user input can include selections made in a user interface provided by the data processing system 140, for example, by a policy administrator.

In certain aspects, the user input can include, for example, a specification or selection of rules that define non-compliant input data and/or non-compliant output data. The non-compliant input data can be defined to include, for example, data deemed to be sensitive. In example, the user input can specify that personally identifying information (PII), such as social security numbers (SSNs), are to be excluded from input data and/or output data. In another example, the user input can specify that personal health information (PHI) is to be excluded from input data and/or output data. In another example, the user input can specify that financial information is to be excluded from the input data and/or the output data. Other examples will be apparent to one skilled in the art after a detailed review of the present disclosure.

In some aspects, the user input can define a scope of applicability of the data policy in terms of particular models or attributes thereof. In an example, the user input can specify that the data policy is generally applicable to all of the external models 132. In another example, the user input can specify that the data policy is generally applicable to all external models of a particular group or class (e.g., all public models supporting generative AI software). In another example, the user input can specify that the data policy is applicable to a particular external model, such as an external model supporting a specific implementation or version of generative AI software. Other examples will be apparent to one skilled in the art after a detailed review of the present disclosure.

In addition, or alternatively, the user input can define a scope of applicability of the data policy based on a requestor that initiates access to one or more of the external models 132. The requestor can be, for example, a user (e.g., inclusive of users and robotic users), system, software application and/or the like. In some aspects, the requestor can be, for example, the data processor 144 and/or a user of the data processor 144. In certain aspects, the user input can define the scope of applicability based on attributes of the requestor, such as a type of requestor (e.g., user, robotic user, software application, etc.), a geographic region of the requestor (e.g., country), a function or role of the requestor (e.g., if the requestor is a human user, or is operating under the authority of a human user), and/or the like. In some aspects, the user input can specify that the data policy is generally applicable to all requestors that attempt to access one or more of the external models 132, regardless of attributes or type. Other examples will be apparent to one skilled in the art after a detailed review of the present disclosure.

At block 404, the policy configurator 362 configures the data policy based on the user input. In some aspects, the block 404 can include generating the data policy, for example, by establishing the one or more rules in a format used by the model gateway 148.

In certain aspects, the configuration by the policy configurator 362 can include generating prompt signatures that are illustrative of compliant input data according to the data policy (e.g., valid prompts to one or more of the external models 132) and/or non-compliant input data according to the data policy (e.g., non-compliant prompts to one or more of the external models 132). In some cases, the policy configurator 362 can create tens, hundreds, or thousands of prompt signatures for one or both of compliant input data and non-compliant input data. In some aspects, some or all of the prompt signatures can be received as part of the user input. In addition, or alternatively, some or all of the prompt signatures can be generated can be based on the user input (e.g., selections that establish certain data types or values that may be included, or selections that establish certain data types or values that are non-compliant). In addition, or alternatively, in some aspects, the policy configurator 362 can receive one or more prompt signatures in the user input and, based thereon, generate additional prompt signatures. In certain aspects, the data policy can include the prompt signatures. In addition, or alternatively, the data policy can be associated with the prompt signatures, for example, in storage.

In some aspects, the data policy can include or be associated with different sets of prompt signatures for different contexts. For example, for a context of medical claims processing, the data policy can include or be associated with prompt signatures illustrative of compliant input data and/or non-compliant input data in a medical claims context. Other examples will be apparent to one skilled in the art after a detailed review of the present disclosure.

At block 406, the policy configurator 362 stores the configured data policy, for example, in the audit engine 370. In some aspects, the configured data policy and/or any associated prompt signatures can be stored in a location accessible to the audit engine 370, such as in the data store(s) 154. After block 406 the process 400 ends.

FIG. 5 illustrates an example of a process 500 for facilitating real-time implementation of secured access to external data models. In certain embodiments, the process 500 can be executed, for example, by the model gateway 148 of FIG. 1 or the core engine 364 of FIG. 3. The process 500 can also be executed generally by the data processing system 140 of FIG. 1. Although the process 500 can be executed by any number of different components, to simplify discussion, the process 500 will be described relative to the core engine 364 of FIG. 3.

At block 502, the core engine 364 intercepts input data directed to an external model such as any of the external models 132 of FIG. 1. As discussed previously, the external model maybe, for example, an LLM. The input data may be directed to the external model by a requestor such as a user, system, or software application. In some cases, the requestor may be the data processor 144 of FIG. 1.

In certain aspects, blocks 504-508 relate to processing the input data prior to its provision to the external model. At block 504, the core engine 364 identifies a context for the input data. The context may indicate, for example, a purpose of the input data and/or a workflow in which the input data is being used (e.g., medical claims processing). In some aspects, the context can be identified based on a textual analysis of the input data. In addition, or alternatively, the context can be identified based on the requestor and/or attributes thereof. For example, particular requestors (e.g., users or software applications) can be mapped to particular contexts.

At block 506, the core engine 364 filters the input data based on an applicable data policy. In some aspects, the block 506 can include, for example, determining the applicable data policy from a plurality of data policies stored in or otherwise accessible to the audit engine 370, for example, based on each policy's scope of applicability, as discussed above relative to FIG. 3. The filtering can include, for example, identifying at least some of the input data as non-compliant data based on the applicable data policy and then removing the non-compliant data therefrom. The non-compliant data may be, for example, data deemed to be sensitive based on the applicable data policy, as discussed relative to FIG. 3.

In some aspects, the filtering at the block 506 can be based on prompt signatures included in or otherwise associated with the applicable data policy. For example, the informetrics engine 366 of the core engine 364 can review the input data by matching words or information from the input data, for example, with prompt signatures illustrative of non-compliant input data. According to this example, the informetrics engine 366 can flag the matched words or information with, or in relation to, a confidence score indicative of a degree of match. The threshold engine 372 can compare each confidence score to a threshold and can filter the flagged data that exceeds the threshold.

At block 508, the core engine 364 filters the input data resulting from the block 506 based on the context identified at the block 504. In certain aspects, the core engine 364 can perform a textual analysis of the input data to identify at least some of the input data as irrelevant data based on the context. Thereafter, the core engine 364 can remove the irrelevant data from the input data.

In some aspects, the filtering at the block 508 can be based on the prompt signatures included in or otherwise associated with the applicable data policy. As discussed previously, the data policy can include different sets of prompt signatures for different contexts. In some aspects, the anomaly engine 368 of the core engine 364 can review the input data by matching words or information from the input data, for example, with prompt signatures illustrative of compliant input data for the context. According to this example, the anomaly engine 368 can identify differences in the input data relative to the prompt signatures illustrative of compliant input data. According to this example, the anomaly engine 368 can flag data corresponding to the identified differences with, or in relation to, a score indicative of a degree of difference. The threshold engine 372 can compare each score to a threshold and can remove the flagged data exceeding the threshold from the input data.

At block 510, the core engine 364 provides the processed input data to the external model. The processed input data can include, for example, the input data as processed (e.g., filtered) during the execution of blocks 504-508. At block 512, the core engine 364 intercepts output data from the external model. In general, the output data is responsive to the processed input data provided to the external model.

In certain aspects, blocks 514 and 516 relate to processing the output data prior to its provision, for example, to the requestor. At block 514, the core engine 364 filters the output data based on the applicable data policy. In general, the block 514 can include executing functionality similar to that which is described relative to the block 506. At block 516, the core engine 364 filters the output data based on the context identified at the block 504. In general, the block 514 can include executing functionality similar to that which is described relative to the block 508. At block 518, the core engine 364 provides the processed output data to a requestor associated with the input data (e.g., a user, system and/or software application). After block 518, the process 500 ends.

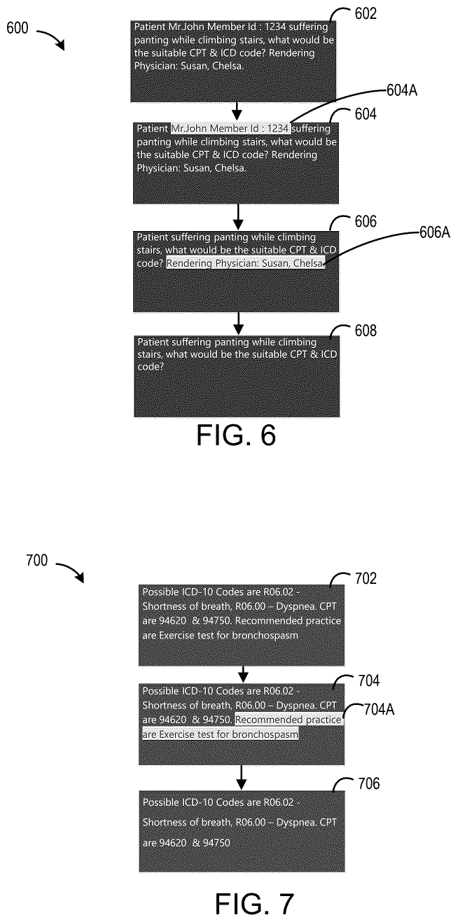

FIG. 6 illustrates an example of processing input data 600, for example, according to the process 500 of FIG. 5. At block 602, the input data 600 is in its original state, for example, as intercepted at the block 502 of FIG. 5. At block 604, non-compliant data 604A is identified in the input data 600, for example, as discussed relative to the block 506 of FIG. 5. In the example of FIG. 6, the non-compliant data 604A includes sensitive information.

At block 606, the input data 600 has been filtered to remove the non-compliant data 604A. In addition, at the block 606, irrelevant data 606A is identified in the input data 600, for example, as discussed relative to the block 508 of FIG. 5. In the example of FIG. 6, the irrelevant data is based on an example context of medical claims processing. At block 608, the input data 600 has been filtered to remove the irrelevant data 606A. In certain aspects, the input data 600, as shown in the block 608, can be provided to an external model as discussed, for example, relative to the block 510 of FIG. 5.

FIG. 7 illustrates an example of processing output data 700, for example, according to the process 500 of FIG. 5. At block 702, the output data 700 is in its original state, for example, as intercepted at the block 512 of FIG. 5. At block 704, irrelevant data 704A is identified in the input data 700, for example, as discussed relative to the block 514 of FIG. 5. In the example of FIG. 7, the irrelevant data is based on an example context of medical claims processing. At block 706, the input data 700 has been filtered to remove the irrelevant data 704A. In certain aspects, the output data 700, as shown in the block 706, can be provided to a requestor as discussed, for example, relative to the block 518 of FIG. 5.

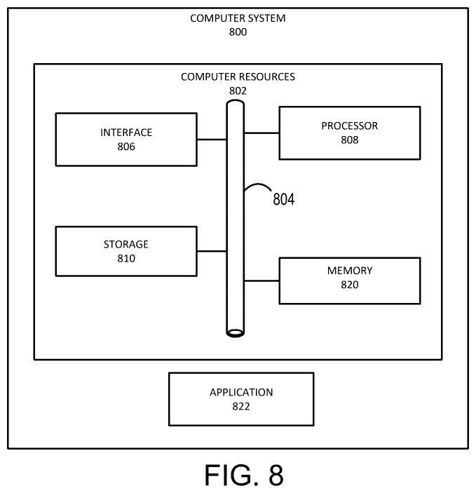

FIG. 8 illustrates an example of a computer system 800. In some cases, the computer system 800 can be representative, for example, of any of the tenant systems 110 or components thereof, the user systems 160, and/or the data processing system 140 or components thereof. The computer system 800 includes an application 822 operable to execute on computer resources 802. In particular embodiments, the computer system 800 may perform one or more actions described or illustrated herein. In particular embodiments, one or more computer systems may provide functionality described or illustrated herein. In particular embodiments, encoded software running on one or more computer systems may perform one or more actions described or illustrated herein or provide functionality described or illustrated herein.

The components of the computer system 800 may include any suitable physical form, configuration, number, type and/or layout. As an example, and not by way of limitation, the computer system 800 may include an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, the computer system 800 may include one or more computer systems; be unitary or distributed; span multiple locations; span multiple machines; or reside in a cloud, which may include one or more cloud components in one or more networks.

In the depicted embodiment, the computer system 800 includes a processor 808, memory 820, storage 810, interface 806 and bus 804. Although a particular computer system is depicted having a particular number of particular components in a particular arrangement, this disclosure contemplates any suitable computer system having any suitable number of any suitable components in any suitable arrangement.

Processor 808 may be a microprocessor, controller, or any other suitable computing device, resource, or combination of hardware, software and/or encoded logic operable to execute, either alone or in conjunction with other components, (e.g., memory 820), the application 822. Such functionality may include providing various features discussed herein. In particular embodiments, processor 808 may include hardware for executing instructions, such as those making up the application 822. As an example, and not by way of limitation, to execute instructions, processor 808 may retrieve (or fetch) instructions from an internal register, an internal cache, memory 820, or storage 810; decode and execute them; and then write one or more results to an internal register, an internal cache, memory 820, or storage 810.

In particular embodiments, processor 808 may include one or more internal caches for data, instructions, or addresses. This disclosure contemplates processor 808 including any suitable number of any suitable internal caches, where appropriate. As an example, and not by way of limitation, processor 808 may include one or more instruction caches, one or more data caches and one or more translation lookaside buffers (TLBs). Instructions in the instruction caches may be copies of instructions in memory 820 or storage 810 and the instruction caches may speed up retrieval of those instructions by processor 808. Data in the data caches may be copies of data in memory 820 or storage 810 for instructions executing at processor 808 to operate on; the results of previous instructions executed at processor 808 for access by subsequent instructions executing at processor 808, or for writing to memory 820, or storage 810; or other suitable data. The data caches may speed up read or write operations by processor 808. The TLBs may speed up virtual-address translations for processor 808. In particular embodiments, processor 808 may include one or more internal registers for data, instructions, or addresses. Depending on the embodiment, processor 808 may include any suitable number of any suitable internal registers, where appropriate. Where appropriate, processor 808 may include one or more arithmetic logic units (ALUs); be a multi-core processor; include one or more processors 808; or any other suitable processor.

Memory 820 may be any form of volatile or non-volatile memory including, without limitation, magnetic media, optical media, random access memory (RAM), read-only memory (ROM), flash memory, removable media, or any other suitable local or remote memory component or components. In particular embodiments, memory 820 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 820 may include one or more memories 820, where appropriate. Memory 820 may store any suitable data or information utilized by the computer system 800, including software embedded in a computer readable medium and/or encoded logic incorporated in hardware or otherwise stored (e.g., firmware). In particular embodiments, memory 820 may include main memory for storing instructions for processor 808 to execute or data for processor 808 to operate on. In particular embodiments, one or more memory management units (MMUs) may reside between processor 808 and memory 820 and facilitate accesses to memory 820 requested by processor 808.

As an example, and not by way of limitation, the computer system 800 may load instructions from storage 810 or another source (such as, for example, another computer system) to memory 820. Processor 808 may then load the instructions from memory 820 to an internal register or internal cache. To execute the instructions, processor 808 may retrieve the instructions from the internal register or internal cache and decode them. During or after execution of the instructions, processor 808 may write one or more results (which may be intermediate or final results) to the internal register or internal cache. Processor 808 may then write one or more of those results to memory 820. In particular embodiments, processor 808 may execute only instructions in one or more internal registers or internal caches or in memory 820 (as opposed to storage 810 or elsewhere) and may operate only on data in one or more internal registers or internal caches or in memory 820 (as opposed to storage 810 or elsewhere).

In particular embodiments, storage 810 may include mass storage for data or instructions. As an example, and not by way of limitation, storage 810 may include a hard disk drive (HDD), a floppy disk drive, flash memory, an optical disc, a magneto-optical disc, magnetic tape, or a Universal Serial Bus (USB) drive or a combination of two or more of these. Storage 810 may include removable or non-removable (or fixed) media, where appropriate. Storage 810 may be internal or external to the computer system 800, where appropriate. In particular embodiments, storage 810 may be non-volatile, solid-state memory. In particular embodiments, storage 810 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 810 may take any suitable physical form and may include any suitable number or type of storage. Storage 810 may include one or more storage control units facilitating communication between processor 808 and storage 810, where appropriate.

In particular embodiments, interface 806 may include hardware, encoded software, or both providing one or more interfaces for communication (such as, for example, packet-based communication) among any networks, any network devices and/or any other computer systems. As an example, and not by way of limitation, communication interface 806 may include a network interface controller (NIC) or network adapter for communicating with an Ethernet or other wire-based network and/or a wireless NIC (WNIC) or wireless adapter for communicating with a wireless network.

Depending on the embodiment, interface 806 may be any type of interface suitable for any type of network for which computer system 800 is used. As an example, and not by way of limitation, computer system 800 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. The computer system 800 may include any suitable interface 806 for any one or more of these networks, where appropriate.

In some embodiments, interface 806 may include one or more interfaces for one or more I/O devices. One or more of these I/O devices may enable communication between a person and the computer system 800. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 806 for them. Where appropriate, interface 806 may include one or more drivers enabling processor 808 to drive one or more of these I/O devices. Interface 806 may include one or more interfaces 806, where appropriate.

Bus 804 may include any combination of hardware, software embedded in a computer readable medium and/or encoded logic incorporated in hardware or otherwise stored (e.g., firmware) to couple components of the computer system 800 to each other. As an example, and not by way of limitation, bus 804 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 804 may include any number, type and/or configuration of buses 804, where appropriate. In particular embodiments, one or more buses 804 (which may each include an address bus and a data bus) may couple processor 808 to memory 820. Bus 804 may include one or more memory buses.

Herein, reference to a computer-readable storage medium encompasses one or more tangible computer-readable storage media possessing structures. As an example, and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 808 (such as, for example, one or more internal registers or caches), one or more portions of memory 820, one or more portions of storage 810, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language. The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

1. A method of securing interaction with public large language models (LLMs), comprising, by a computer system:
intercepting input data to a public LLM;
processing the input data based on a data policy applicable to the public LLM;
providing the processed input data to the public LLM;
intercepting output data from the public LLM that is responsive to the processed input data;
processing the output data based on the data policy applicable to the public LLM; and
providing the processed output data to a requestor associated with the input data.

2. The method of claim 1, wherein the processing comprises filtering the input data based on the data policy.

3. The method of claim 2, wherein the filtering comprises:
identifying at least some of the input data as non-compliant data based on the data policy; and
removing the non-compliant data from the input data.

4. The method of claim 3, wherein the non-compliant data comprises data deemed to be sensitive based on the data policy.

5. The method of claim 3, wherein the processing further comprises:
identifying a context for the input data;
identifying at least some of the input data as irrelevant data based on the context; and
removing the irrelevant data from the input data.

6. The method of claim 1, wherein the processing comprises filtering the output data based on the data policy.

7. The method of claim 6, wherein the filtering comprises:
identifying at least some of the output data as non-compliant data based on the data policy; and
removing the non-compliant data from the output data.

8. The method of claim 6, wherein:
the processing the input data further comprises identifying a context for the input data; and
the processing the output data further comprises:
identifying at least some of the output data as irrelevant data based on the context; and
removing the irrelevant data from the output data.

9. The method of claim 1, wherein the data policy applicable to the public LLM varies based on an attribute of at least one of the requestor or a user associated with the requestor.

10. The method of claim 1, further comprising:
receiving user input for the data policy; and
configuring the data policy based on the user input.

11. A system comprising a processor and memory, wherein the processor and memory in combination are operable to implement a method comprising:
intercepting input data to a public LLM;
processing the input data based on a data policy applicable to the public LLM;
providing the processed input data to the public LLM;
intercepting output data from the public LLM that is responsive to the processed input data;
processing the output data based on the data policy applicable to the public LLM; and
providing the processed output data to a requestor associated with the input data.

12. The system of claim 11, wherein the processing comprises filtering the input data based on the data policy.

13. The system of claim 12, wherein the filtering comprises:
identifying at least some of the input data as non-compliant data based on the data policy; and
removing the non-compliant data from the input data.

14. The system of claim 13, wherein the non-compliant data comprises data deemed to be sensitive based on the data policy.

15. The system of claim 13, wherein the processing further comprises:
identifying a context for the input data;
identifying at least some of the input data as irrelevant data based on the context; and
removing the irrelevant data from the input data.

16. The system of claim 11, wherein the processing comprises filtering the output data based on the data policy.

17. The system of claim 16, wherein the filtering comprises:
identifying at least some of the output data as non-compliant data based on the data policy; and
removing the non-compliant data from the output data.

18. The system of claim 16, wherein:
the processing the input data further comprises identifying a context for the input data; and
the processing the output data further comprises:
identifying at least some of the output data as irrelevant data based on the context; and
removing the irrelevant data from the output data.

19. The system of claim 11, wherein the method further comprises:
receiving user input for the data policy; and
configuring the data policy based on the user input.

20. A computer-program product comprising a non-transitory computer-usable medium having computer-readable program code embodied therein, the computer-readable program code adapted to be executed to implement a method comprising:
intercepting input data to a public LLM;
processing the input data based on a data policy applicable to the public LLM;
providing the processed input data to the public LLM;
intercepting output data from the public LLM that is responsive to the processed input data;
processing the output data based on the data policy applicable to the public LLM; and
providing the processed output data to a requestor associated with the input data.
